(19) United States
(12) Patent Application Publication
(10) Pub. No.: US 2007/0113380 A1
(43) Pub. Date: May 24, 2007

(54) Umbrella handle (III)

(76) Inventors: Youth Lee, Taipei City (TW); Jung Chien Tsai, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/283,957

(22) Filed: Nov. 22, 2005

(51) Int. Cl. B25G 1/10

(52) U.S. Cl. 16/431

(57) ABSTRACT

The invention relates to an umbrella handle with a soft contact surface for comfortable holding. The umbrella includes a central rod, soft layers, and engaged bars or holders with apertures, wherein the soft layers are provided around the central rod and engaged bars or holders are placed over the soft layers. An upper cap and a bottom cap are connected from both ends of the central rod to fix the soft layers and the bars or the holders with the rod in secure as an umbrella handle. The soft layer is provided with many hollow projections, which are elastic and easily deformable that provides a soft contact for comfortable feeling when holding the umbrella handle.

### BACKGROUND OF THE INVENTION

A known umbrella handle is usually made of hard material, such as plastic, wood, or metal. When user holds the hard handle for a period of time, he will occasionally feel uncomfortable or even painful. This disturbs the utilization of conventional umbrellas.

The present invention is to overcome the drawback of prior art and to provide an invented umbrella handle, which includes a soft layer with multiple hollow projections to cover the handle for providing an excellent contact feeling. Now, accompanying with the following drawings, the character of the present invention will be described here and after.

### BRIEF DESCRIPTION OF THE DRAWINGS

FIG. 1 is a perspective view showing an umbrella handle according to the present invention.

FIG. 2 is an exploded perspective view of FIG. 1.

FIG. 3 is a top plan view of FIG. 1.

FIG. 4 is a cross-sectional plan view alone line 4-4 of FIG. 3.

FIG. 5 is an exploded perspective view showing a modified umbrella handle of FIG. 1.

FIG. 6 is a plan view showing the umbrella handle connected with an umbrella according to the present invention.

FIG. 7 is a perspective view showing another modified embodiment according to the present invention.

FIG. 8 is an exploded perspective view of FIG. 7.

FIG. 9 is a semi cross-sectional plan view of FIG. 7.

FIG. 10 is an exploded perspective view showing a modified umbrella handle of FIG. 7.

### DETAILED DESCRIPTION OF THE PREFERRED EMBODIMENT

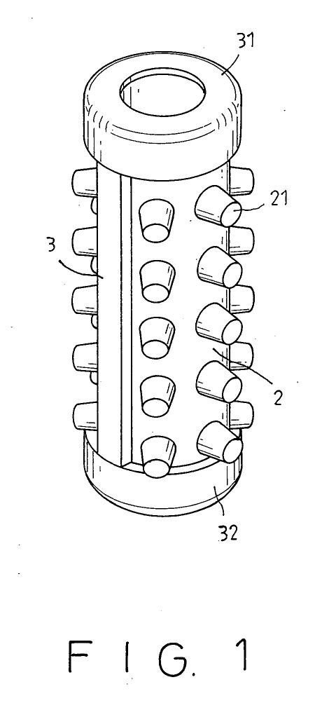

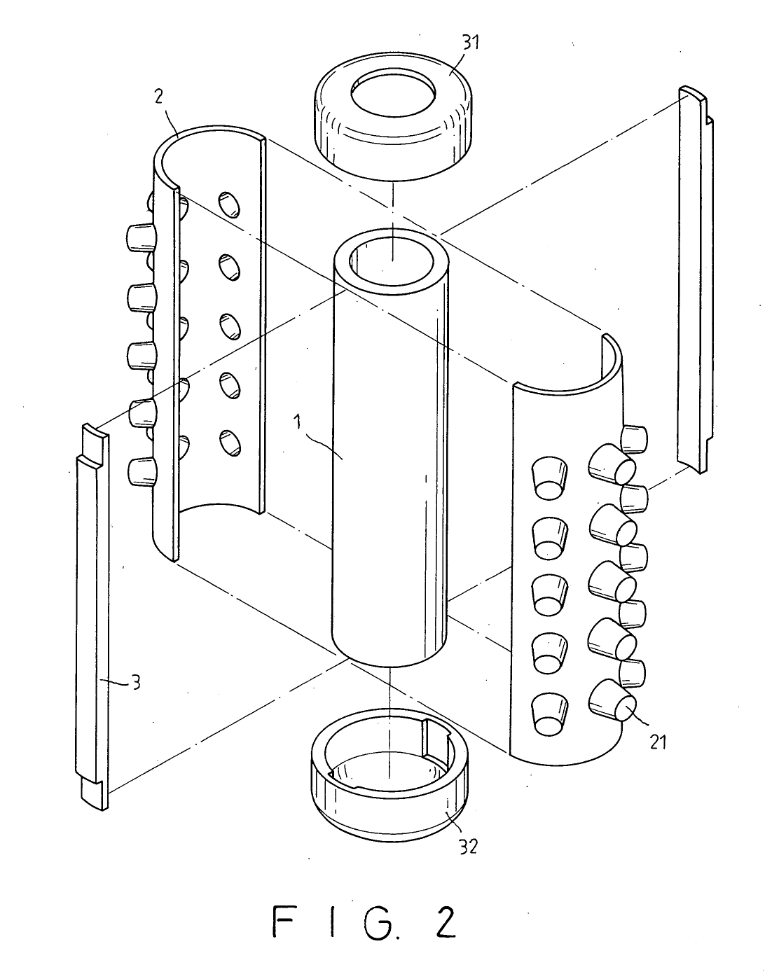

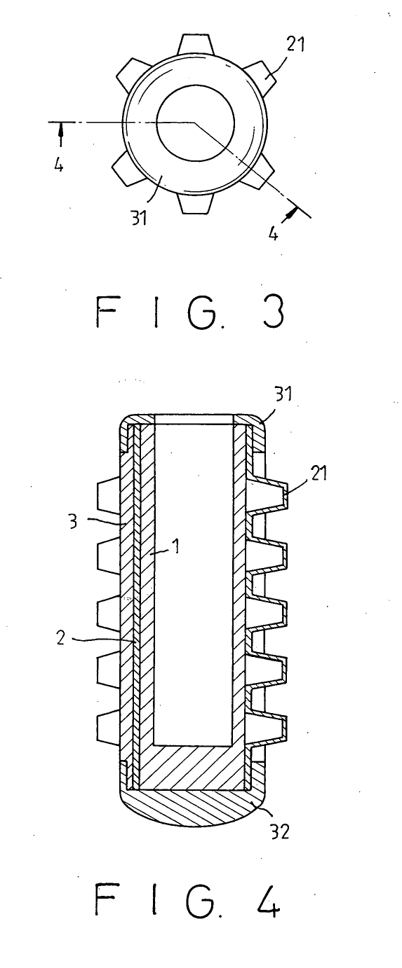

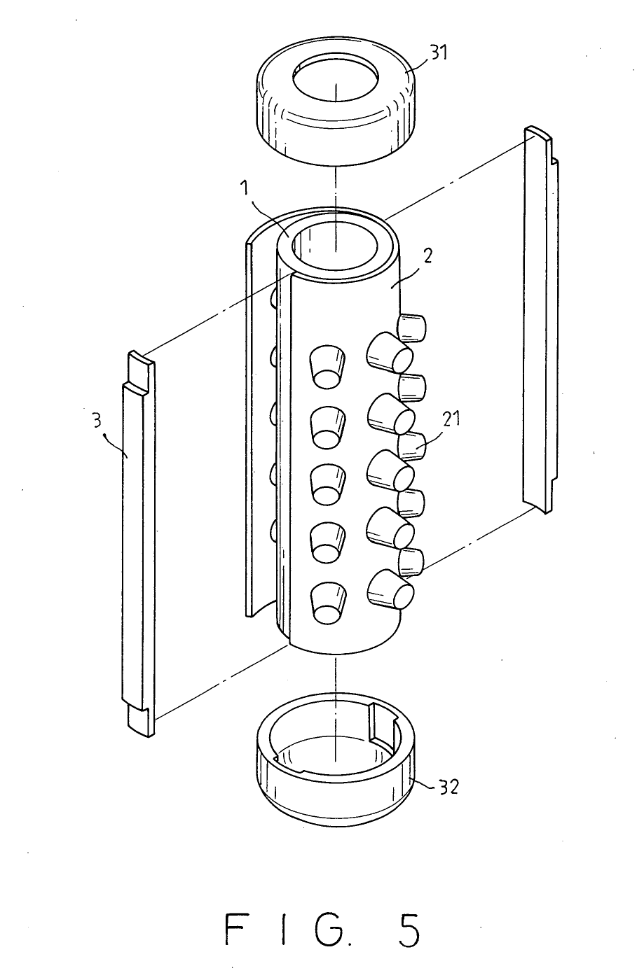

Referring to FIG. 1 to 4, the present invention relates to an improved umbrella handle, which includes a central rod (1), two soft layers (2), and two engaged bars (3). The soft layers (2) are provided around the central rod (1) and two engaged bars (3) are placed alone the contact rims of two layers (2). Then, an upper cap (31) and a bottom cap (32) are connected from both ends of the central rod (1) to connect the soft layers (2) and the bars (3) with the rod (1) in secure. as an umbrella handle. The soft layer (2) is provided with many hollow projections (21), which are elastic and easily deformable. When a user holds the umbrella handle, he will feel comfortable because of the soft contact with the deformable projections (21). Referring to FIG. 5, it shows a modified structure of above umbrella handle of the present invention, wherein the soft layer (2) can be formed as one single piece to cover the central rod (1) that reaches the same effect of soft contact with the umbrella handle.

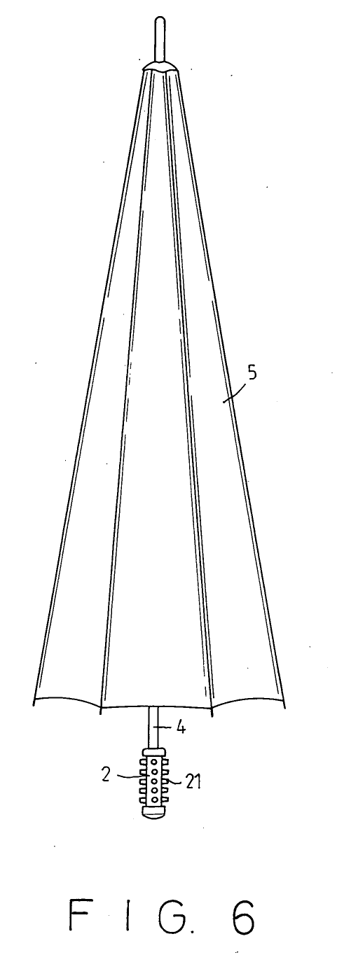

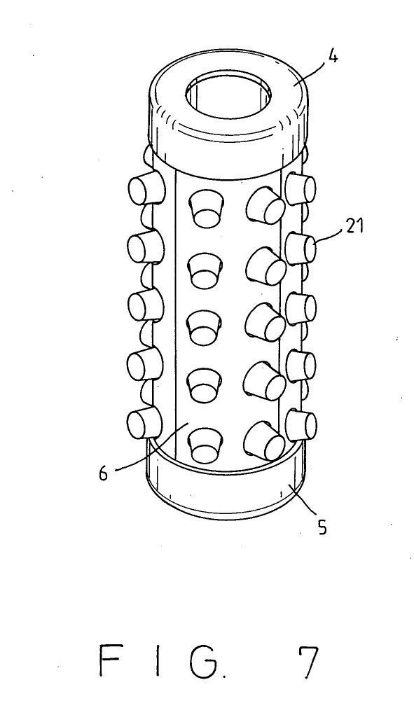

In use, as shown in FIG. 6, the central rod (1) is connected with a shaft (4) of the umbrella (5). At this time, the soft handle according to the present invention can provide users to hold the umbrella with ease that promotes the value and progress.

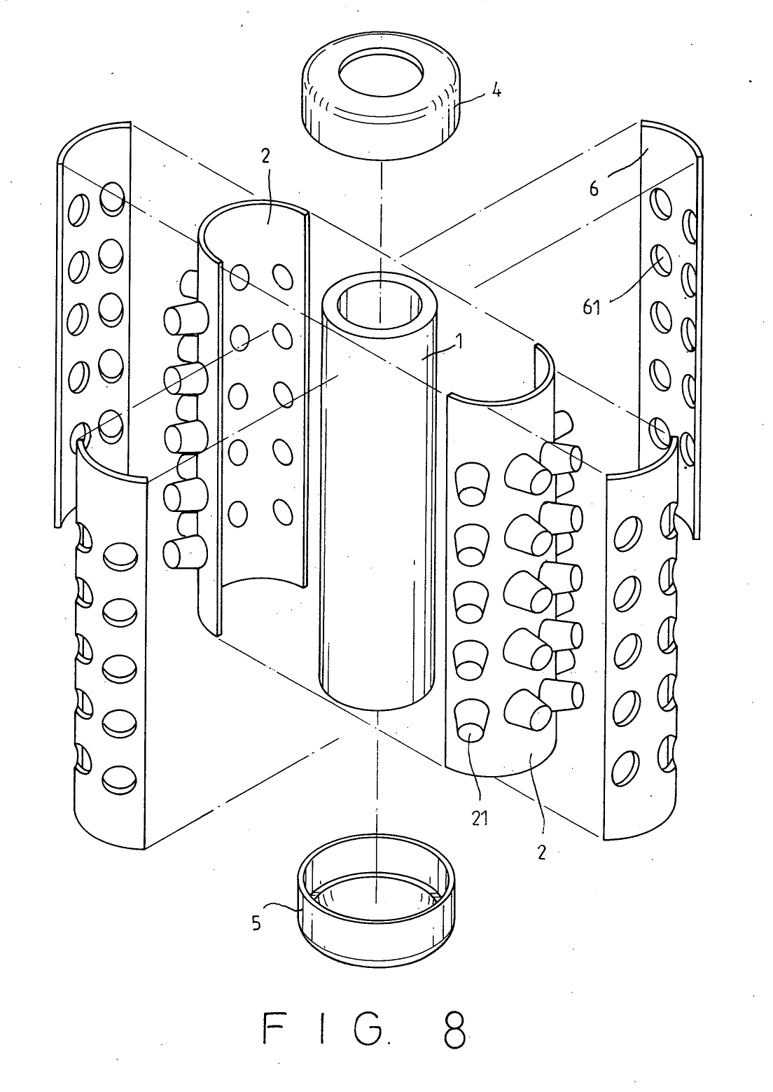

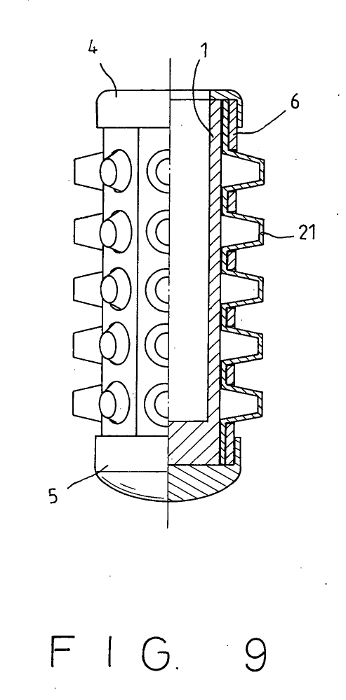

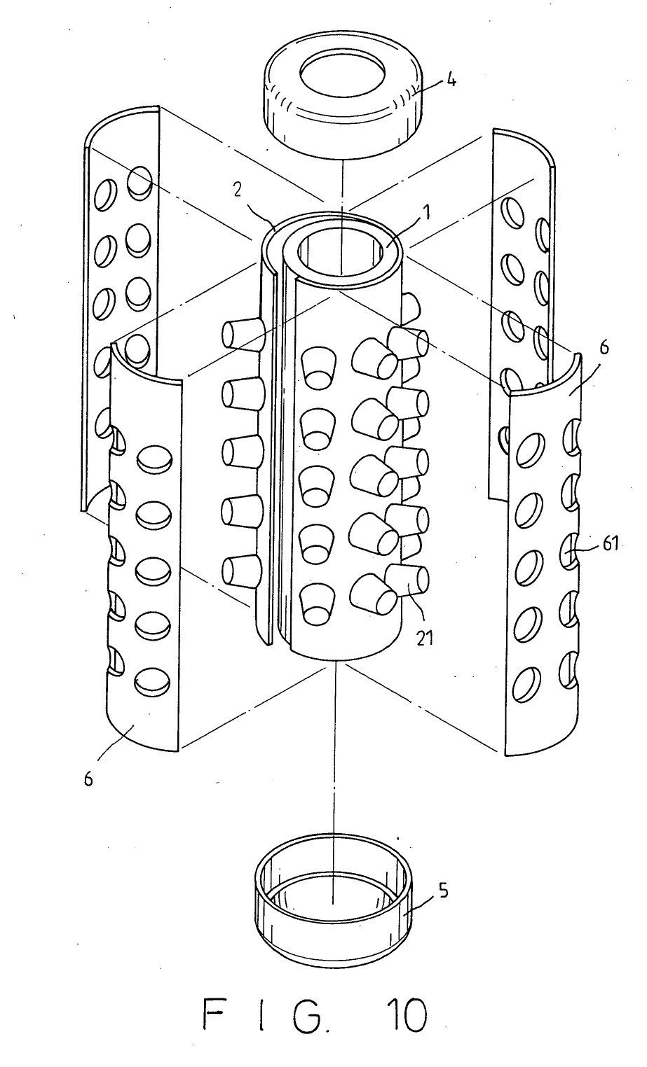

Please refer to FIG. 7 to 9; it is another embodiment with the same merit of this invention. The umbrella handle includes a central rod (1) and two soft layers (2) with multiple hollow projections (21). Several holders (6) having many apertures (61) are covered on the soft layers (2), wherein each aperture (61) allows a related projection (21) extending outward. The upper cap (4) and the bottom cap (5) are connected from both ends of the rod (1) to engage all elements together firmly. This embodiment can also obtain the perfect soft effect for holding by users. FIG. 10 shows a modified structure of FIG. 7, wherein the soft layer (2) is a single piece instead of two pieces to consist a complete circular.

Accordingly, it can be understood that the above-mentioned embodiments are only exemplary of the present invention. Any modification with the same or similar merit is still claimed in this application.

I claim:

1. An umbrella handle (III) including a central rod, two soft layers, and two engaged bars, wherein the soft layers are provided around the central rod and two engaged bars are placed alone the contact rims of two layers; an upper cap and a bottom cap connected from both ends of the central rod to fix the soft layers and the bars with the rod in secure as an umbrella handle, and the soft layer being provided. with many hollow projections, which are elastic and easily deformable.

2. The umbrella handle (III) as claimed in claim 1, wherein the soft layer can be one pieces or several pieces to consist a circular cover around the central rod.

3. An umbrella handle (III) including a central rod, two soft layers, and several holders, wherein the soft layers are provided around the central rod and the holders are placed over the soft layers; an upper cap and a bottom cap connected from both ends of the central rod to fix the soft layers and the holders with the rod in secure as an umbrella handle; the soft layer being provided with many hollow projections, which are elastic and easily deformable, and the holder being provided with multiple apertures relating to the projections.

4. The umbrella handle (III) as claimed in claim 3, wherein the soft layer can be one pieces or several pieces to consist a circular cover around the central rod.
